(19) United States
(12) Patent Application Publication
(10) Pub. No.: US 2005/0089675 A1
(43) Pub. Date: Apr. 28, 2005

(54) Partially collapsible structure

(76) Inventor: John Taylor Christiansen, Dallas, TX (US)

Correspondence Address: Robert M. Mason, 13601 Preston Rd., 402W, Dallas, TX, 75240, US

(21) Appl. No.: 10/692,253

(22) Filed: Oct. 23, 2003

(51) Int. Cl. B32B 1/00

(52) U.S. Cl. 428/174

(57) ABSTRACT

A partially collapsible structure made from foldable sheet material includes a series of longitudinal folds and transverse folds defining alternate longitudinal rigid strips and longitudinal collapsible strips. Each longitudinal rigid strip includes a series of generally rectangular portions joined in the longitudinal direction and substantially equidistant in the transverse direction. In an alternate form, each longitudinal strip is a series of generally quadrilateral portions joined in the longitudinal direction and substantially equidistant in the transverse direction. Each longitudinal collapsible strip includes a generally quadrilateral-shaped portion such that all quadrilateral shaped portions within each longitudinal collapsible strip are not comprised of a series of folds defining 3 right isosceles triangular shaped areas. The structure may be laminated on either or both sides for additional strength. Further, the collapsible strips may be fixed in the collapsed form by gluing or other adhering process.

### BACKGROUND OF THE INVENTION

This invention relates to the field of foldable sheet material, and more particularly to a partially collapsible structure made from foldable sheet material.

Several prior patents have addressed folded material in which the folds are of a specific arrangement so that the material may be used in making articles for various purposes. For example, U.S. Pat. No. 4,780,344 to Hoberman discloses firm three-dimensional expanded enclosures made from essentially two-dimensional collapsible structures. U.S. Pat. No. 4,981,732 to Hoberman discloses firm stable three-dimensional expanded structures that can be collapsed down to compact bundles. U.S. Pat. No. 5,234,727 to Hoberman also discloses compacting larger structures.

U.S. Pat. No. 4,049,855 to Cogan discloses a honeycomb type core configuration for composite structural panels generated by folding sheet material. The box shaped core, when attached to a surface sheet imparts rigidity to the sheet for use as a high strength to weight ratio structural sheet panel. The cell walls of the folded core are integral with the cell bottom, which provides a large surface area for ease of attachment to the surface sheet.

None of these prior patents teach or suggest a partially collapsible structure as is disclosed herein.

### BRIEF SUMMARY OF THE INVENTION

It is an object of the present invention to provide a folding pattern for foldable sheet material such that when folded, the sheet material provides structural integrity.

It is a further object of the present invention to provide a folding pattern for foldable sheet material such that the sheet material when folded is partially collapsible, yet also rigid.

It is also an object of the present invention to provide a set of folding operations such that when sheet material is folded, a variety of partially collapsed structures results.

In accordance with a preferred embodiment of the present invention, a partially rigid and partially collapsible foldable sheet material having a longitudinal direction and a transverse direction generally perpendicular to the longitudinal direction comprises at least one longitudinal rigid strip that is partially rigid and partially collapsible in the transverse direction and at least one alternating longitudinal collapsible strip that is collapsible in the transverse direction; the longitudinal rigid strip is formed of generally quadrilateral portions, each generally quadrilateral portion of the same rigid strip being generally the same dimension in the transverse direction; the longitudinal collapsible strip is formed of at least one quadrilateral-shaped portion.

Other objects and advantages will become apparent from the following descriptions, taken in connection with the accompanying drawings, wherein, by way of illustration and example, an embodiment of the present invention is disclosed.

### BRIEF DESCRIPTION OF THE SEVERAL DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIGS. 1A, 1B, 1C, and 1D are views in various stages of collapse of a partially collapsible structure in accordance with a preferred embodiment of the present invention.

FIGS. 2A, 2B, 2C, and 2D are views in various stages of collapse of a partially collapsible structure in accordance with an alternate embodiment of the present invention.

FIGS. 3A, 3B, 3C, and 3D are views in various stages of collapse of a partially collapsible structure in accordance with another alternate embodiment of the present invention.

FIGS. 4A, 4B, and 4C are views in two stages of collapse of a partially collapsible structure in accordance with another alternate embodiment of the present invention.

FIGS. 5A, 5B, and 5C are views in various stages of collapse of a partially collapsible structure in accordance with another alternate embodiment of the present invention.

FIGS. 6A, 6B, and 6C are views in various stages of collapse of a partially collapsible structure in accordance with another alternate embodiment of the present invention.

FIGS. 7A and 7B are views in two stages of collapse of a partially collapsible structure in accordance with another alternate embodiment of the present invention.

FIG. 8 is a perspective view of a partially collapsible structure in accordance with another alternate embodiment of the present invention.

### DETAILED DESCRIPTION OF THE PREFERRED EMBODIMENTS

Detailed descriptions of the preferred embodiments are provided herein. It is to be understood, however, that the present invention may be embodied in various forms. Various aspects of the invention may be inverted, or changed in reference to specific part shape and detail, part location, or part composition. Therefore, specific details disclosed herein are not to be interpreted as limiting, but rather as a basis for the claims and as a representative basis for teaching one skilled in the art to employ the present invention in virtually any appropriately detailed system, structure or manner.

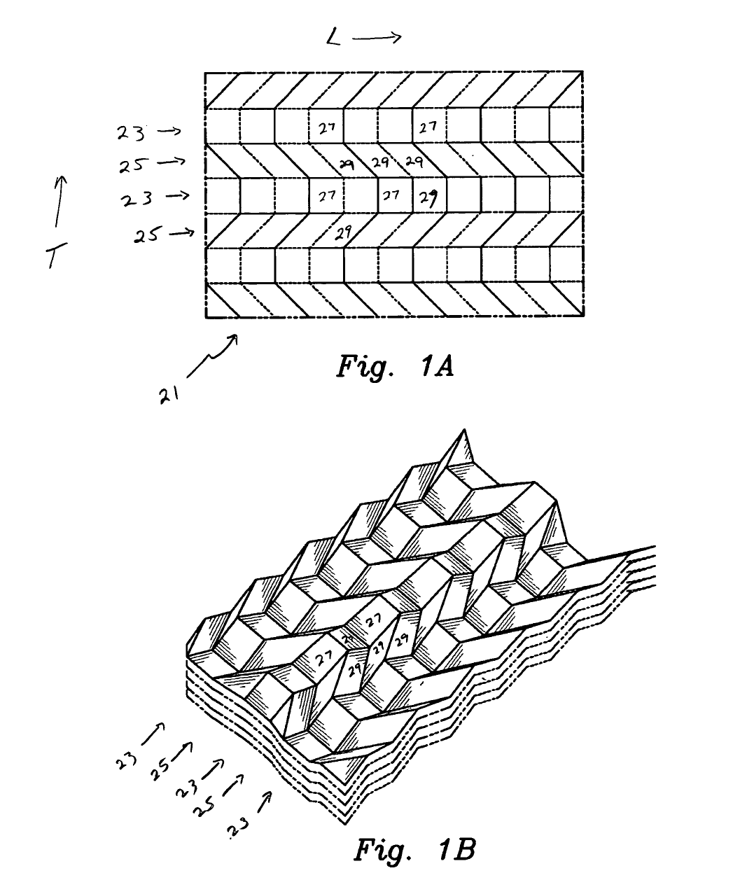

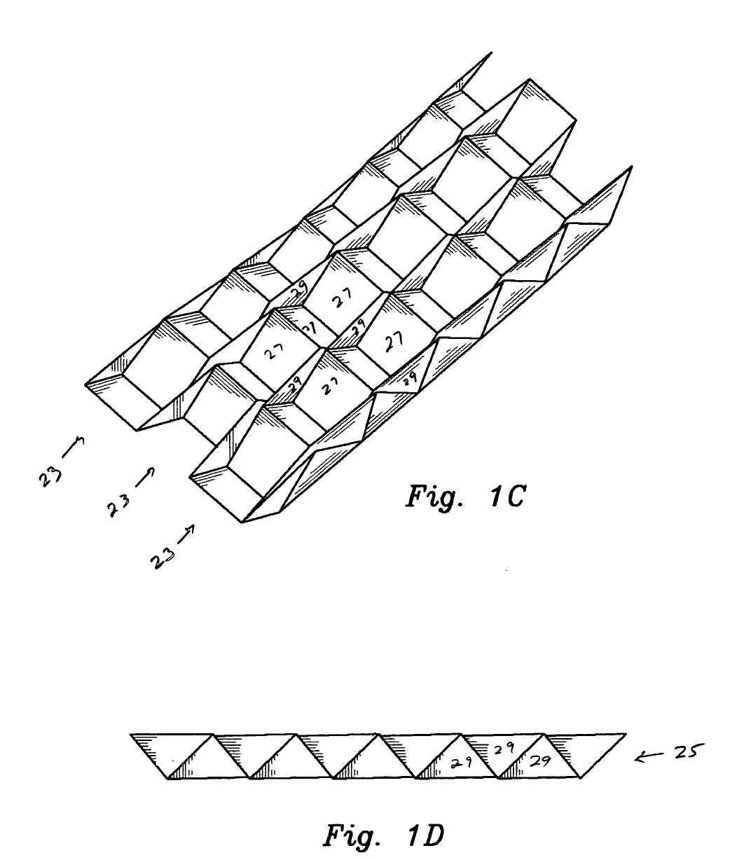

Turning first to FIGS. 1A through 1D, there is shown a partially collapsible foldable sheet structure in accordance with a preferred embodiment of the present invention. One direction of sheet 21 is identified as the longitudinal direction, as is shown by the arrows labeled L. The perpendicular direction of sheet 21 is labeled the transverse direction and has identifying label and arrows T. It will be appreciated that the longitudinal and transverse directions are for descriptions purposes only and that there is no implication intended that one direction is longer than the other because of the labels chosen.

Sheet 21 includes alternating rigid strips or sections 23 and collapsible strips or sections 25. Each strip 23, 25 is oriented in the longitudinal direction and includes sections along the strip. It will be appreciated that as shown in FIG. 1, the rigid strips 23 and collapsible strips 25 are in a particular number, the invention is not so limited to any particular number of rigid or collapsible strips 23, 25, respectively. It is important that, in the transverse direction, one rigid strip 23 is followed, or preceded, by a collapsible strip 25, there is no limitation to the total number of rigid strips 23 or collapsible strips 25. The outer edges of sheet 21 are shown having phantom lines to indicate the outer edge shape and particular number of rigid strips and collapsible strips are not of significant importance to the present invention. For example, there can be only one rigid strip 23 and only one collapsible strip 25. Alternately, there can be only one rigid strip 23 with two collapsible strips 25, one on either side. Continuing, there can be one collapsible strip 25 and two rigid strips 23, one on either side. It will be appreciated that in all embodiments of the inventions described herein, these alternate embodiments relating to the number of strips of collapsible and rigid strips is applicable.

Further as shown in FIG. 1A, sheet 21 is folded in a certain pattern. Sheet folds in one direction are shown having solid lines, while sheet folds in the opposite directions are shown in dashed lines in FIG. 1A. This convention is maintained in the illustration of the flat sheet of each embodiment throughout the description of the invention, regardless of the embodiment described.

As is evident from FIG. 1A, longitudinal rigid strips 23 are formed by a series of quadrilateral portions 27. In the embodiment shown, each quadrilateral portion 27 is a square, though it will be appreciated that the quadrilateral portions 27 may also be of rectangles that are not squares, or parallelograms and still keep within the intentions of the present invention. Further, though shown having a specific number of quadrilateral portions 27 in FIG. 1, there is no such limitation in accordance with the present invention. The number of quadrilateral portions 27 within each longitudinal rigid strip 23 is of no consequence to the invention, and may be designed in accordance with a particular application of the invention. This is the case regardless of the particular embodiment being described throughout.

It is also appreciated form FIG. 1A, each quadrilateral portion 27 within a particular longitudinal strip 23 has substantially the same transverse dimension. This is the case regardless of the particular embodiment being described throughout.

In addition, though it is apparent form FIG. 1 that sheet 21 has regular, straight edges on all sides, the shape of the edges are of no consequence to the present invention, and may be of any shape as is necessary for the particular application of the invention. This is the case regardless of the particular embodiment being described throughout.

Further, as is evident from FIG. 1A, each longitudinal collapsible strip 25 is a mirror image of it's nearest or closest longitudinal collapsible strip 25, such is not necessitated by the present invention, as will be seen in alternate embodiments discussed below.

Continuing with FIG. 1A, each longitudinal collapsible strip 25 is formed by a series of quadrilateral portions 29. Although in FIG. 1, there is shown a specific number of quadrilateral portions 29 in FIG. 1, there is no such limitation in accordance with the present invention. The number of quadrilateral portions 29 within each longitudinal collapsible strip 25 is of no consequence to the invention, and may be designed in accordance with a particular application of the invention. This is the case regardless of the particular embodiment being described throughout.

Turning now to FIGS. 1B and 1C, it is evident that, because of the folding pattern of the alternate longitudinal rigid strips 23 and longitudinal collapsible strips 25, as sheet 21 is folded and compressed in the transverse direction, collapsible strips 25 fold such that some of one surface portion 29 touches some of adjacent surface portion 29. In contrast, when folded, none of one portion 27 of longitudinal rigid strip 23 touches any of adjacent portion 27. It is appreciated that when compressed in the transverse direction, longitudinal rigid strips 23 provide transverse structural rigidity, while longitudinal collapsible strips 25 provide the overall collapsed shape of sheet 21, as viewed from the longitudinal cross section perspective.

This is evident in more detail from inspection of FIG. 1D wherein is shown a collapsed longitudinal collapsible strip 25. Each longitudinal collapsible strip 25 defines two surfaces, one top sided and the other bottom sided. In addition, each longitudinal collapsible strip 25 defines two edges. It is at the surface that the longitudinal collapsible strip 25 collapses and at the edges where the longitudinal collapsible strip 25 joins a longitudinal rigid strip 23. In the embodiment illustrated in FIGS. 1A through 1D, only one edge of collapsible strip 25 is visible when collapsible strip is folded in the fully compressed form and viewed from one side or the other side. As is evident from inspection of alternate embodiments herein described, one edge of longitudinal collapsible strip 25 will always be visible when collapsible strip is fully compressed, though portions of the opposite edge may also be visible. This is the case regardless of the particular embodiment being described throughout.

It will be appreciated that when sheet 21 is in the fully folded and transversely compressed configuration compression in the longitudinal direction also occurs. When so compressed, the surfaces of longitudinal collapsible strip 25 may be fixed together in a variety of ways including using a variety of glues or staples or otherwise so that sheet 21 may retain the collapsed rigid structure. It will also be appreciated that the surfaces of longitudinal collapsible strip 25 may not need to be fixed. For example, sheet 21 may be inserted in a box or other structure that will in effect maintain the transverse pressure on sheet 21 thereby maintaining sheet 21 in the compressed configuration. In this example, sheet 21, when removed form the box, may be expanded to the state shown in, for example FIG. 1A or FIG. 1B. This is the case regardless of the particular embodiment being described throughout.

Further, depending upon the embodiment, when folded, each sheet 21 may be nested one on top of the other, as is shown in FIG. 1D in phantom lines.

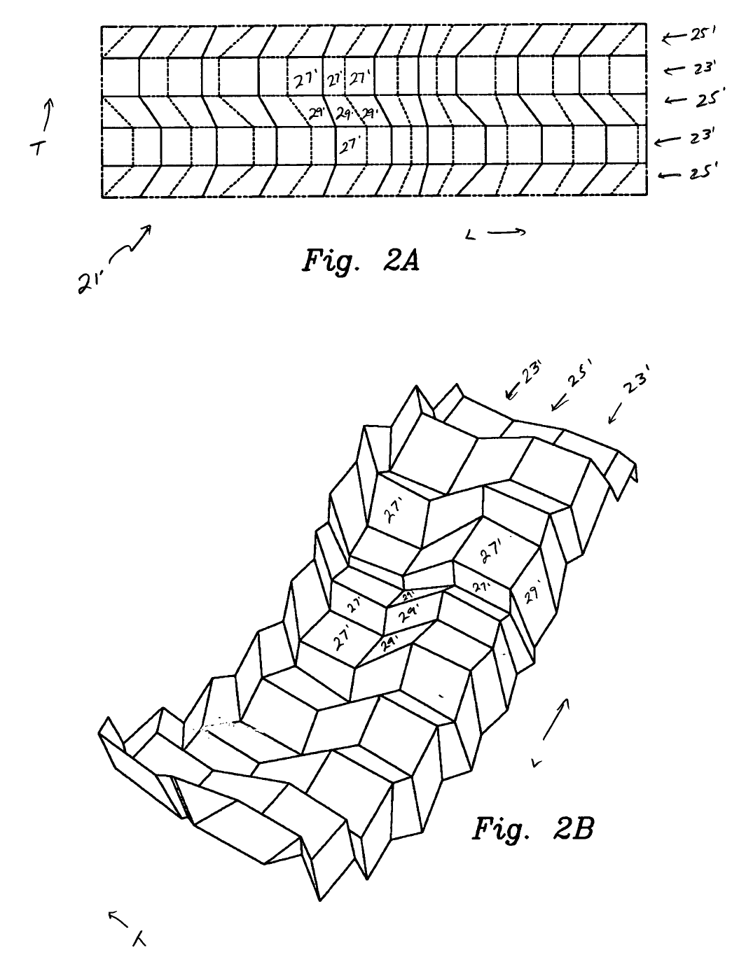

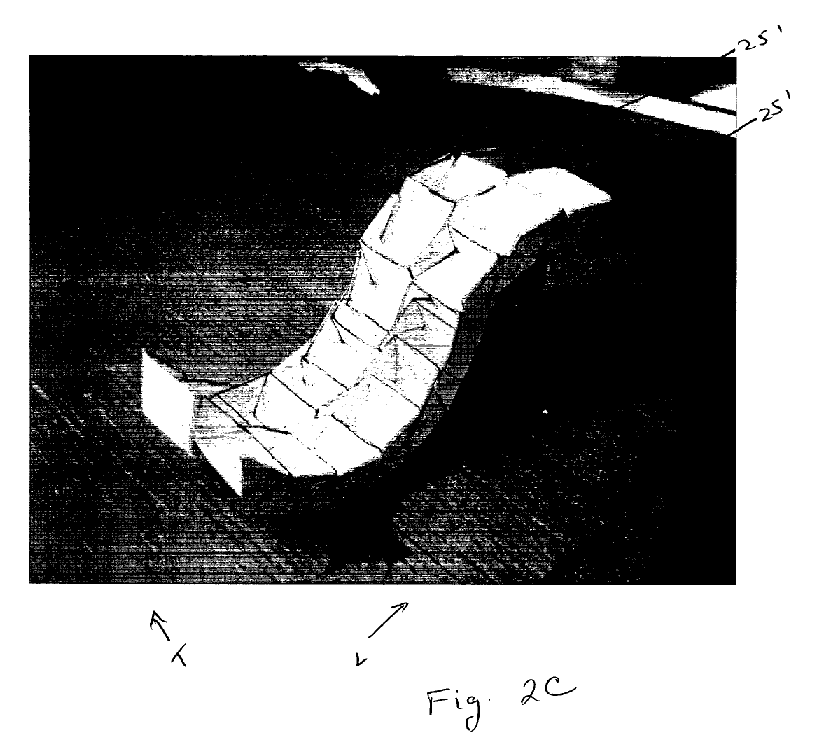

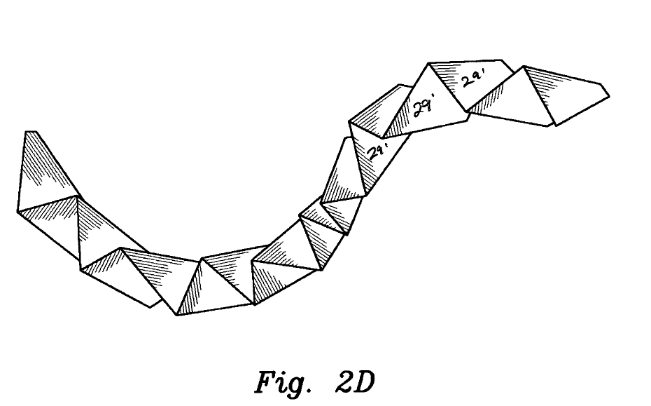

Turning now to FIGS. 2A through 2D, where similar elements will be identified with similar numbers, there is shown an alternate embodiment of the present invention. Specifically, longitudinal collapsible sheet 21′ is having longitudinal rigid strip 23′ of a series of varying quadrilateral portions 27′, each able to have a different parallelogram shape. In addition, longitudinal collapsible strip 25′ is from a series of quadrilaterals, though not necessarily parallelograms. As is shown in FIGS. 2B and 2C, once folded and compressed in the transverse direction, the cross-sectional shape can be varied significantly. The particular folding pattern of longitudinally collapsible strip 25′ is shown in FIG. 2D.

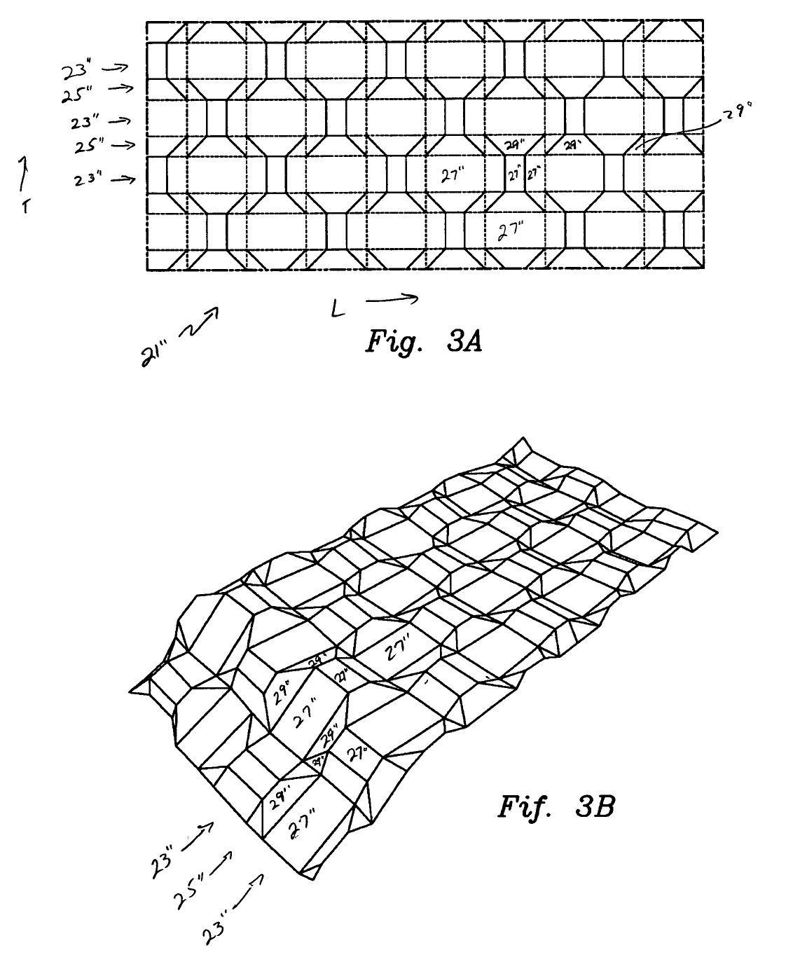

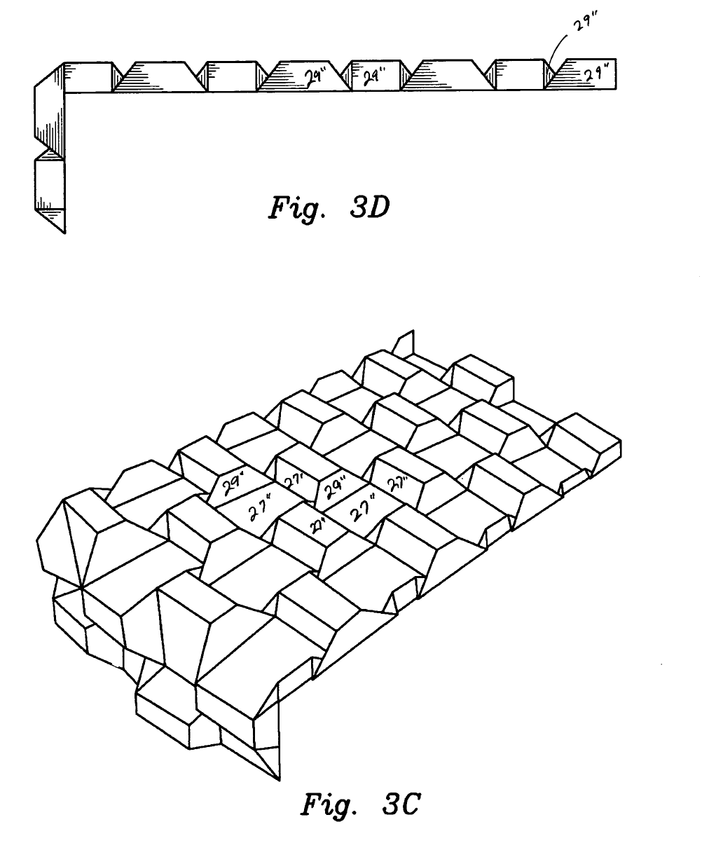

Turning now to FIGS. 3A though 3D, there is shown an alternate embodiment of the foldable sheet in accordance with the present invention. FIG. 3A illustrates the folding pattern on sheet 21″. There is shown the alternating longitudinal collapsible strip 25″ and longitudinal rigid strip 23″. Longitudinal rigid strip 23″ includes a series of rigid portions 27″ in parallelogram shape, specifically rectangles. Particular attention is drawn to longitudinal collapsible strips 25″ formed of a series of folds defining both quadrilaterals and triangles. This series of folds, when compressed in the transverse direction, create a structure as shown in FIGS. 3B and 3C and has the longitudinal collapsible strip 25″ profile as shown in FIG. 3D. Longitudinal collapsible strip 25″ is formed from a pattern of folding lines that define a series of geometric shapes, and in the illustrated embodiment these shapes include triangles and quadrilaterals. From inspection of FIG. 3A it is immediately apparent that the folding pattern of the longitudinal collapsible strip at no point defines a series of three successive triangles two of which are right isosceles triangles equal in area and bordering a third right isosceles triangle twice the area of either the other two. It will be appreciated that by varying the dimensions of the folds within the longitudinal collapsible strip 25″ and the longitudinal rigid strip 23″, a variety of box-like structures may be formed when sheet 21″ is in the compressed, folded formation.

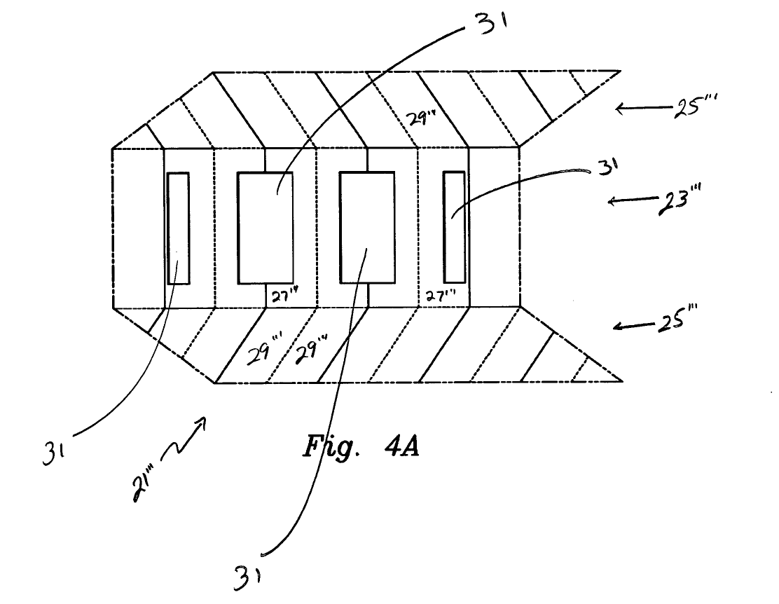

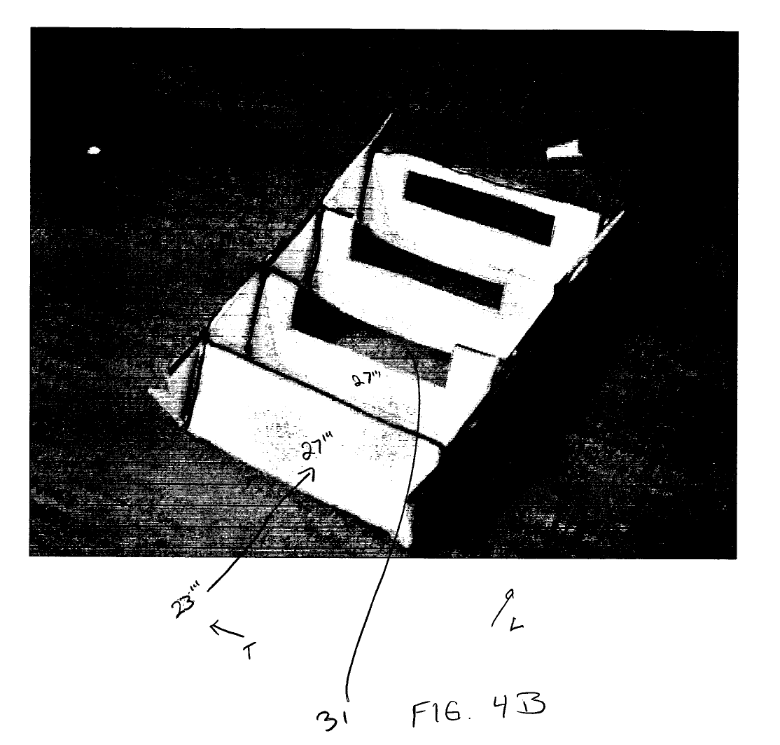

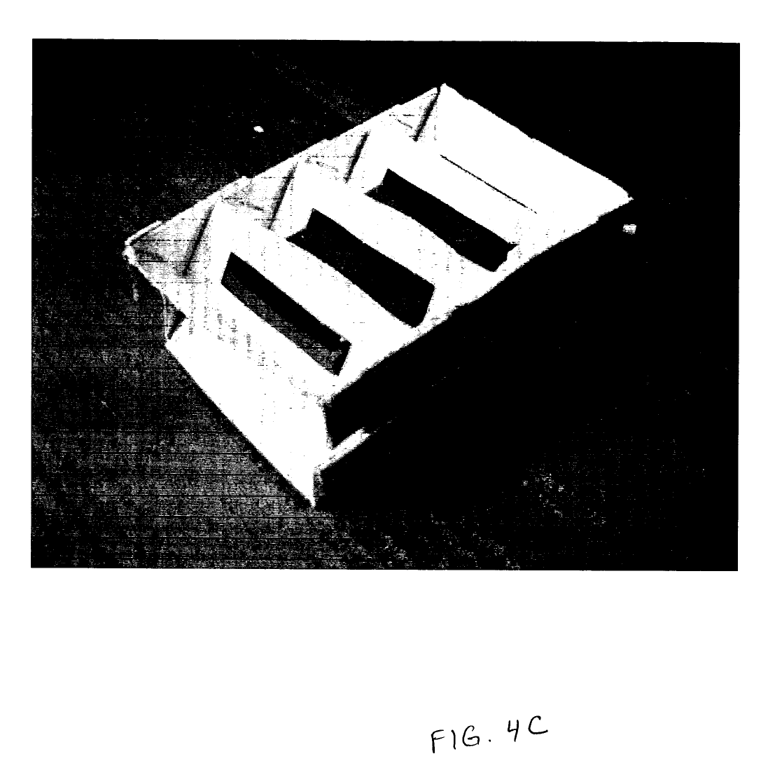

Turning next to FIGS. 4A and 4B, there is shown an alternate embodiment of the present invention. Specifically, there is shown within longitudinal rigid strips 23′″ cut-away material 31, such that when transversely compressed there exists a removed portion 32 in which an object 33 can be placed, for example, shipping the object and providing protection during shipping. It will be appreciated that a variety of designs of cut-away material 31 may be employed for any desired application. For example, in FIG. 4A, cut-away material 31, at times crosses between one quadrilateral portion 27′″ of longitudinal rigid strip 23′″, but is not necessary for the present invention. Cut-away material may be in any portion of rigid strip 23′″ as is needed for the particular application. In addition, and although not shown, cut-away material 31 may be within longitudinal collapsible strip 25′″ and may be within a particular quadrilateral portion or may cut across more than one quadrilateral portion with longitudinal collapsible strip 25′″. Further, cut-away material 31 may span one or more quadrilateral portions between longitudinal collapsible strip 25′″ and longitudinal rigid strip 23′″, or any combination of the above described embodiments. FIG. 4B illustrates the sheet of FIG. 4A when folded, while FIG. 4C illustrates two folded sheets such as that shown in FIG. 4A and further showing a structure that may be fit between the two folded sheets as crated by the cut-away material.

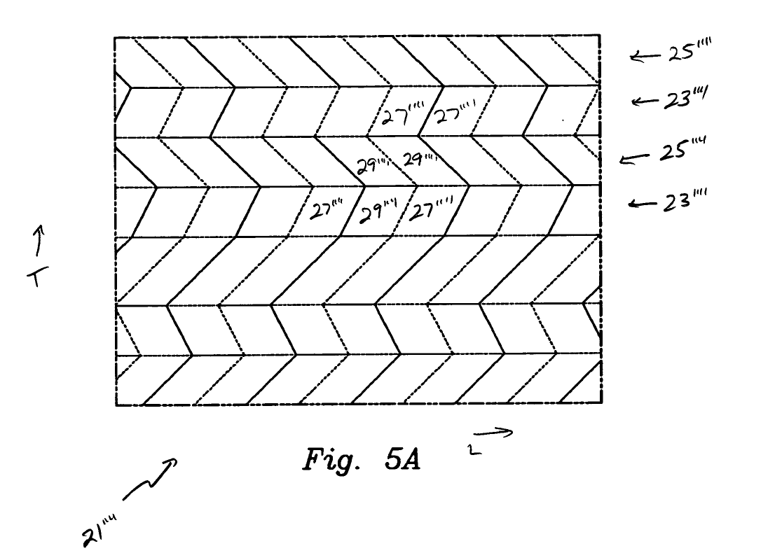

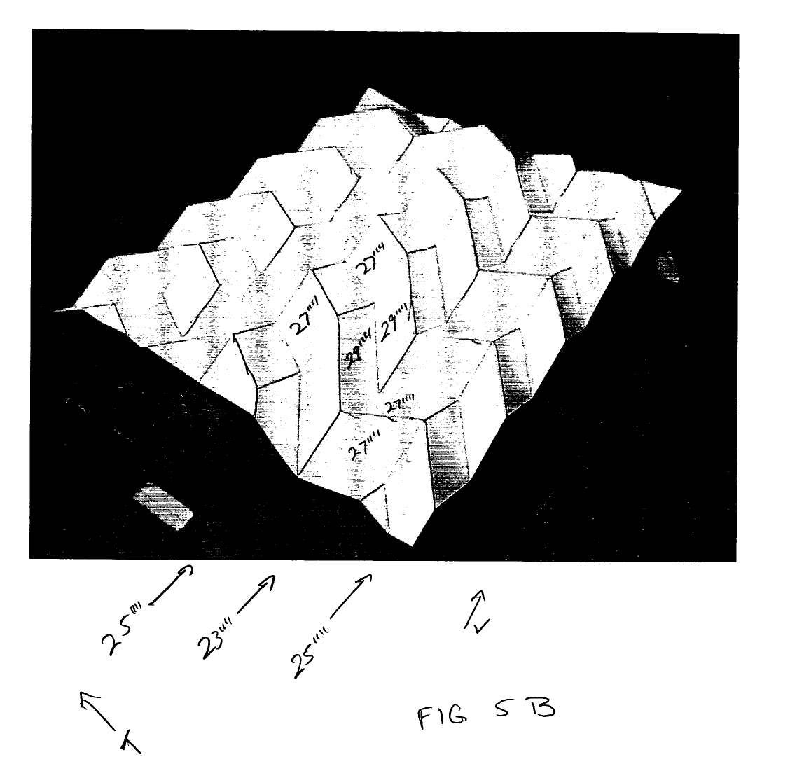

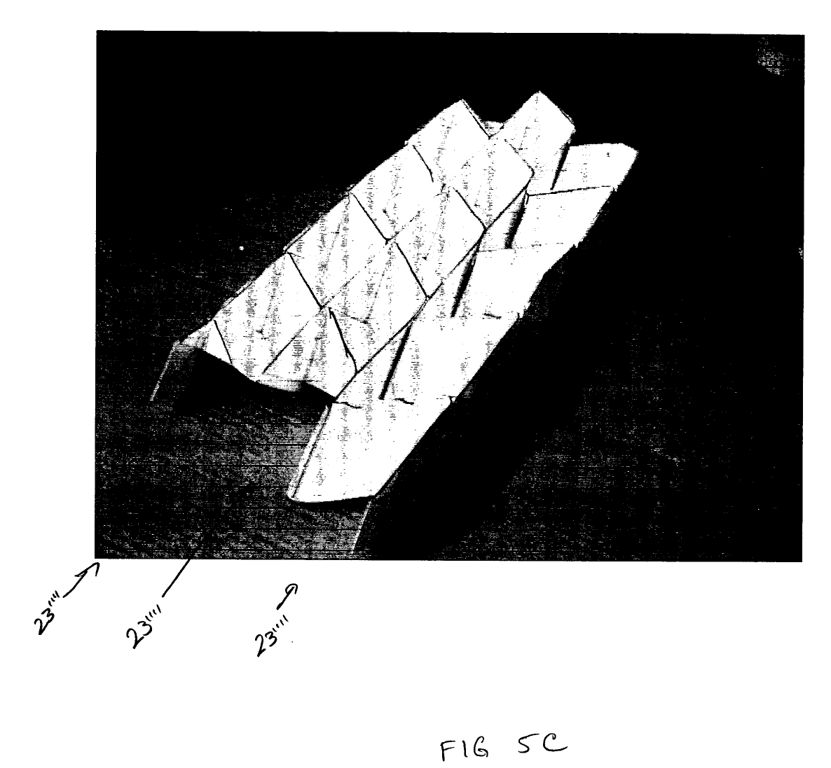

Turning next to FIGS. 5A through 5C there is shown an alternate embodiment of the present invention wherein longitudinal rigid strip 25″″ is formed of a series of quadrilateral portions 29″″, not rectangles. As is clear from FIGS. 5B and 5C, when transversely compressed in the folded formation, a structure is formed as shown. Longitudinal rigid strip 23″″ is partially collapsed in the transverse direction due to the folding pattern. Indeed, in all embodiments, the longitudinal rigid strip is partially collapsible, though in many of the above-described embodiments, the part collapsible is nothing. As is clear form the illustrated embodiments, each longitudinal strip, whether collapsible or rigid, is formed having parallel edges. It is the angel between the parallel edges and the edges of the parallelograms that form the quadrilateral portions within each longitudinal rigid strip that determine the degree to which the longitudinal rigid strip is collapsible. This is the case regardless of the particular embodiment being described throughout. Accordingly, the term rigid as used herein is to refer to the portion that is not entirely collapsible when the sheet is folded and fully compressed, rather than limiting the rigid strip to any degree of collapsibility.

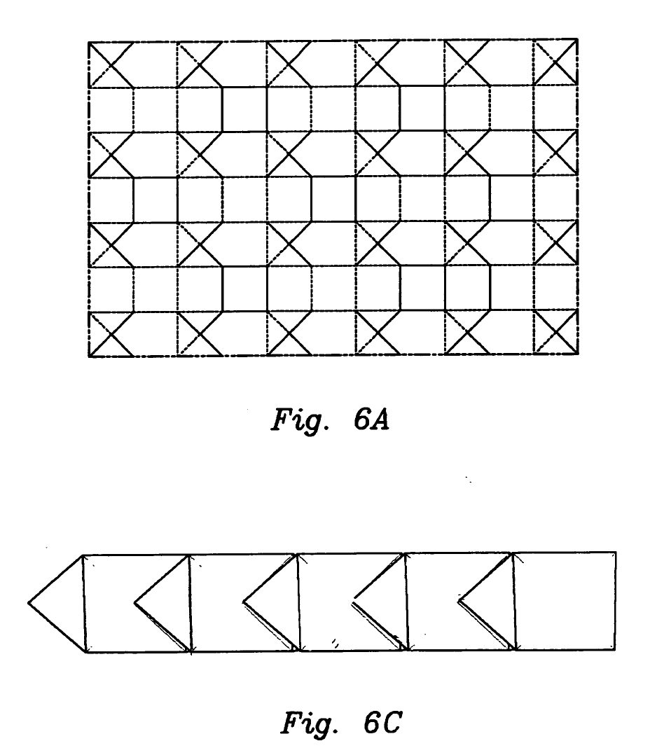

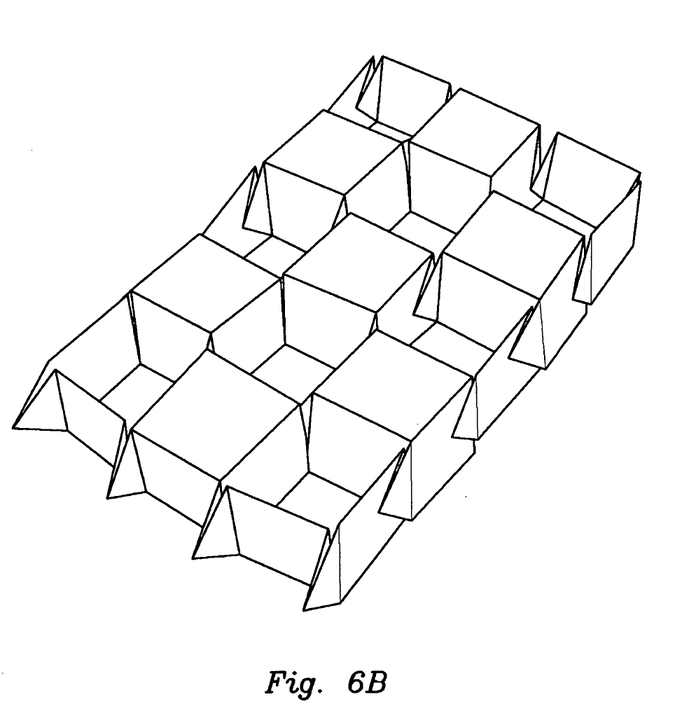

Turning now to FIGS. 6A though 6C, there is shown an alternate embodiment of the present invention. Folding pattern illustrated in FIG. 6A results, when fully folded and compressed in the 3-dimensional checkerboard structure shown in FIG. 6B. Longitudinal collapsible strip, when folded is shown from a side view in FIG. 6C. As is evident from inspection of FIG. 6A, in this particular embodiment, the designation between the longitudinal direction and the transverse direction may be interchanged without consequence. Important to the invention, longitudinal collapsible strip is formed from a pattern of folding lines that define a series of geometric shapes, and in the illustrated embodiment, these shapes include triangles and quadrilaterals. From inspection of FIG. 6A it is immediately apparent that the folding pattern of the longitudinal collapsible strip at no point defines a series of three successive triangles two of which are right isosceles triangles equal in area and bordering a third right isosceles triangle twice the area of either the other two.

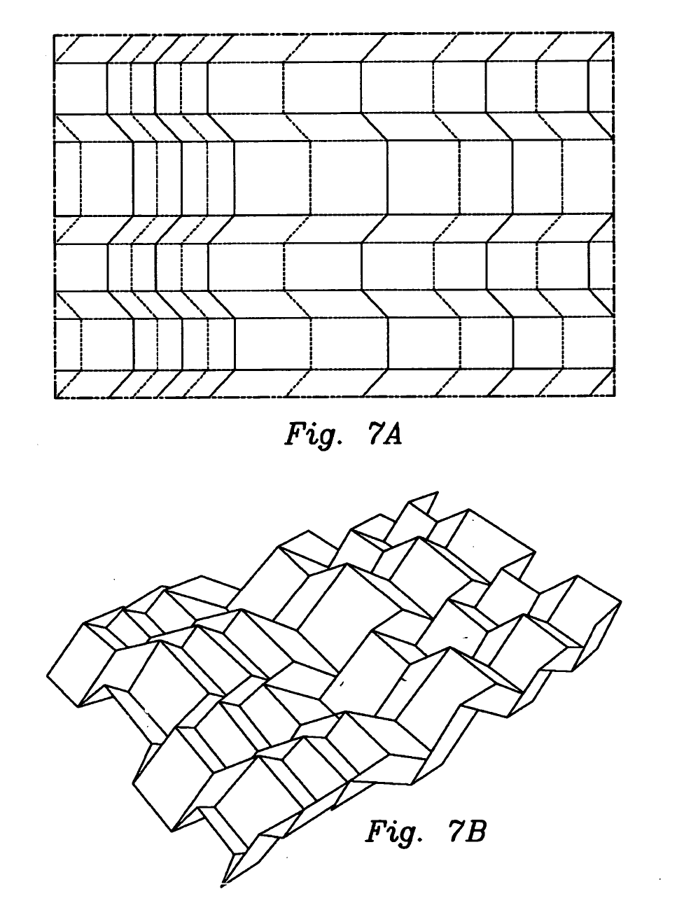

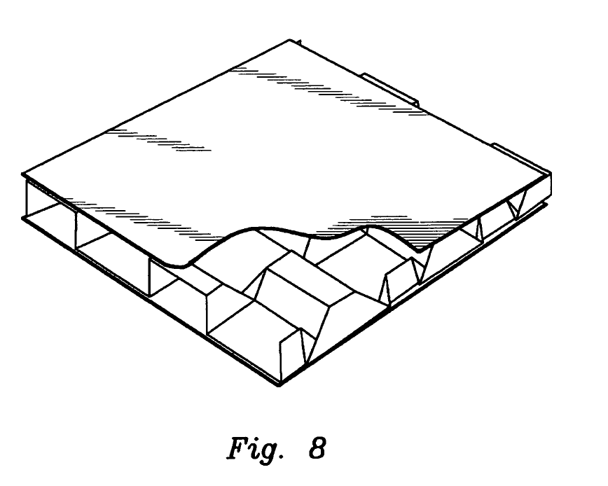

As an alternate example of a foldable sheet in accordance with the present invention, FIGS. 7A and 7B illustrate an alternate design, though the invention is not intended to be limited to the particular embodiments shown.

In addition, as is illustrated in FIG. 8, the foldable structure, once transversely compresses may be laminated on the top side. Though not illustrated, bottom side lamination is also in accordance with the present invention, as is lamination from the top and bottom side in the same structure. The laminating material may be of any appropriate type including, without limitation, paper, cardboard, metal, plastic, etc.

It will be appreciated that sheet 21 may be of any foldable material as is appropriate for a desired application. For example, sheet 21 may be metal, paper, plastic, cardboard, a composite material, etc.

While the invention has been described in connection with preferred embodiments, it is not intended to limit the scope of the invention to the particular forms set forth, but on the contrary, it is intended to cover such alternatives, modifications, and equivalents as may be included within the spirit and scope of the invention as defined by the appended claims.

1. Partially rigid and partially collapsible foldable sheet material having a longitudinal direction and a transverse direction generally perpendicular to the longitudinal direction comprising:
a. alternating longitudinal rigid strips that are rigid in the transverse direction and longitudinal collapsible strips that are collapsible in the transverse direction;
b. the longitudinal rigid strips are formed of generally parallelogram shaped portions, each generally parallelogram shaped portion of the same rigid section being generally the same dimension in the transverse direction; and
c. longitudinal collapsible sections are formed of at least one quadrilateral-shaped portion and formed such that any longitudinal collapsible section is the mirror image of its nearest longitudinal collapsible section

2. Partially rigid and partially collapsible foldable sheet material as claimed in claim 1 wherein the longitudinal collapsible sections are formed of quadrilateral portions.

3. Partially rigid and partially collapsible foldable sheet material of claim 1 further comprising:
a lamination portion adhered to a top side or a bottom side or both top and bottom side of the collapsible structure.

4. Partially rigid and partially collapsible foldable sheet material of claim 1 wherein the collapsible sections are retained in the collapsed structure by adhering one surface portion to another surface portion.

5. A partially collapsible structure made from foldable sheet material comprising:
a. longitudinal collapsible sections separated by longitudinal rigid sections;
b. the longitudinal rigid sections are formed by a series of rectangular portions having substantially uniform transverse dimensions within each section;
c. the longitudinal collapsible sections are formed by a series of geometric-shaped portions, at least one of which is a quadrilateral; and
d. adjacent longitudinal rigid sections and longitudinal collapsible sections meet at an edge such that when the collapsible section is collapsed and forms two opposite surfaces, one entire edge is not covered when viewed from one surface.

6. A partially collapsible structure made from foldable sheet material as claimed in claim 5 wherein the longitudinal collapsible sections are formed of quadrilateral portions.

7. A partially collapsible structure made from foldable sheet material as claimed in claim 6 wherein one or more of the quadrilateral portions include folds that define triangular areas.

8. A partially collapsible structure made from foldable sheet material as claimed in claim 5 wherein one or more of the quadrilateral portions include triangular areas.

9. A partially collapsible structure made from foldable sheet material as claimed in claim 5 further comprising:
a lamination portion adhered to a top side or a bottom side or both top and bottom side of the collapsible structure.

10. A partially collapsible structure made from foldable sheet material as claimed in claim 5 wherein the collapsible sections are retained in the collapsed structure by adhering one surface portion to another surface portion.

11. A partially collapsible structure made from foldable sheet material comprising:
a. a series of longitudinal folds and transverse folds defining alternate longitudinal rigid strips and longitudinal collapsible strips;
b. each longitudinal rigid strip comprising a series of generally rectangular portions joined in the longitudinal direction and substantially equidistant in the transverse direction;
c. each longitudinal collapsible strip comprising a generally quadrilateral-shaped portion such that all quadrilateral shaped portions within each longitudinal collapsible section are not comprised of a series of 3 right isosceles triangular shaped areas.

12. A partially collapsible structure of claim 11 further comprising:
a lamination portion adhered to a top side or a bottom side or both top and bottom side of the collapsible structure.

13. A partially collapsible structure of claim 11 wherein the collapsible sections are retained in the collapsed structure by adhering one surface portion to another surface portion.

14. Partially rigid and partially collapsible foldable sheet material having a longitudinal direction and a transverse direction generally perpendicular to the longitudinal direction comprising:
a. At least one longitudinal rigid strip that is partially rigid and partially collapsible in the transverse direction and at least one alternating longitudinal collapsible strip that is collapsible in the transverse direction;
b. the longitudinal rigid strip is formed of generally quadrilateral portions, each generally quadrilateral portion of the same rigid strip being generally the same dimension in the transverse direction;
c. the longitudinal collapsible strip is formed of at least one quadrilateral-shaped portion.

15. Partially rigid and partially collapsible foldable sheet material of claim 14 comprising:
two or more rigid strips separated by a collapsible strip.

16. Partially rigid and partially collapsible foldable sheet material of claim 14 comprising:
two or more collapsible strips separated by a rigid strip.

17. Partially rigid and partially collapsible foldable sheet material of claim 15 wherein any longitudinal collapsible section is the mirror image of its nearest longitudinal collapsible section.

18. Partially rigid and partially collapsible foldable sheet material of claim 14 further comprising:
a lamination portion adhered to a top side or a bottom side or both top and bottom side of the collapsible structure.

19. Partially rigid and partially collapsible foldable sheet material of claim 14 wherein the collapsible sections are retained in the collapsed structure by adhering one surface portion to another surface portion.
